(19) United States
(12) Patent Application Publication
(10) Pub. No.: US 2008/0074379 A1
(43) Pub. Date: Mar. 27, 2008

(54) Gate Drive Circuit and Display Apparatus Having the Same

(76) Inventors: Sung-Man Kim, Seoul (KR); Hyeong-Jun Park, Cheonan-si (KR); Kyung-Wook Kim, Seoul (KR); Byeong-Jae Ahn, Suwon-si (KR); Beom-Jun Kim, Seoul (KR); Bong-Jun Lee, Seoul (KR); Jong-Hyuk Lee, Seoul (KR); Shin-Tack Kang, Seongnam-si (KR); Yu-Jin Kim, Asan-si (KR)

Correspondence Address: MACPHERSON KWOK CHEN & HEID LLP, 2033 GATEWAY PLACE, SUITE 400, SAN JOSE, CA, 95110, US

(21) Appl. No.: 11/859,516

(22) Filed: Sep. 21, 2007

(30) Foreign Application Priority Data
Sep. 25, 2006 (KR) 2006-92957

(51) Int. Cl. G09G 3/36

(52) U.S. Cl. 345/99; 345/92; 345/94

(57) ABSTRACT

A gate drive circuit of a display device includes a plurality of stages, each stage being coupled to at least one other stage. A current stage among the stages includes a gate section, a carry section, a buffer section, and a reset section. The gate section generates a current gate signal and the carry section generates a current carry signal. The buffer section receives a previous carry signal from a previous stage, and then turns on the gate section and the carry section. The reset section receives a next carry signal from next stages, and then turns off the gate section and the carry section. As the current stage is reset in response to the next carry signal, the function of the gate drive circuit is increased.

### CROSS REFERENCE TO RELATED APPLICATION

This application claims the priority of Korean Patent Application No. 10-2006-092957 filed on Sep. 25, 2006. The entire disclosure of application is incorporated herein by reference.

### BACKGROUND OF THE INVENTION

1. Field of the Invention

This invention relates to a gate drive circuit, and a display device using the gate drive circuit, and more particularly to a gate drive circuit which provides improved performance of the display device.

2. Description of the Related Art

A liquid crystal displays includes a liquid crystal display panel having a lower substrate, an upper substrate and a liquid crystal layer therebetween to display a desired image. The liquid crystal display panel comprises a plurality of gate lines, data lines, and pixels coupled to the gate lines and the data lines.

Also, the liquid crystal display device includes a gate drive circuit sequentially providing gate pulses to the gate lines and a data drive circuit providing pixel voltages to the data lines. In general, the gate drive circuit and the data drive circuit are formed in one chip or individual chips are mounted on the liquid crystal display panel in the form of film.

In order to minimize the number of chips required, a Gate IC Less (GIL) structure which provides the gate drive circuit is directly formed on the lower substrate through a thin film manufacturing process has been introduced. In the liquid crystal display device adopting the GIL structure, the gate drive circuit includes a shift resister with plural stages, each stage being coupled to another stage.

However, as the size of the liquid crystal display becomes larger and the resolution of the display becomes higher, the number of gate lines and pixels are increased. Therefore, the resistance of the gate line is increased which results in distortion resulting from gate signal delay.

In the prior art, each stage in the gate drive circuit is reset in response to a next stage gate signal. However, if a distortion happens at the next gate signal, reset function of each stage in the gate drive circuit is not well implemented.

### SUMMARY

Accordingly, it is an aspect of the present invention to provide a gate drive circuit for display device.

In order to achieve this invention, a gate drive circuit having a plurality of stages is provided. The gate drive circuit includes a current stage, at least one previous stage coupled to the current stage, and at least one next stage coupled to current stage. The current stage includes a gate section generating a current gate signal, a carry section generating a current carry signal, a buffer section receiving a previous carry signal from the previous stage to turn on the gate section and the carry section in response to the previous carry signal, and a reset section receiving a next carry signal from the next stage to turn off the gate section and the carry section.

The reset section includes a first reset transistor being operative to turn off the gate section and to turn off the carry section in response to the next carry signal, and a second reset transistor being operative to discharge the current gate signal in response to the next carry signal.

Also, the first reset transistor includes a control electrode receiving the next carry signal, an input electrode receiving a gate off voltage, and an output electrode coupled to the gate section and to a control terminal of the carry section. The second transistor includes a control electrode receiving the next carry signal, an input electrode receiving a gate off voltage, and an output electrode coupled to an output terminal of the gate section.

In the gate drive circuit, the gate section includes an output transistor having a control electrode coupled to an output terminal of the buffer section, an input electrode receiving a first clock, and an output electrode generating the current gate signal. The carry section includes a carry transistor having a control electrode coupled to the output terminal of the buffer section, an input electrode receiving the first clock, and an output electrode outputting the current carry signal. The buffer section includes a buffer transistor of which a control electrode and an input electrode are electrically connected to each other to commonly receive the previous carry signal, and an output electrode coupled to control electrode of the output transistor of the gate section and to control electrode of the carry transistor of the carry section. Meanwhile, the current stage further includes a holding section to hold the current gate signal with discharge, an inverter section receiving the first clock and the current gate signal, and generating an inverted signal for the current gate signal to turn on or turn off the holding section, a ripple protection section receiving the first clock and the second clock which is an inverted signal of the first clock and preventing signals providing to the gate section and the control electrode of the carry section from being rippled, and a frame reset section resetting the current stage in response to a last gate signal from a last stage among stages.

According to the present invention, the display device includes a display panel, a data drive circuit, and a gate drive circuit. The display panel displays a desired image with a plurality of gate lines, a plurality of data lines, and a plurality of pixels and the data drive circuit coupled to the data lines provides a data signal.

The gate drive circuit includes a plurality of stages connected to each other one after another. Each of the plurality of stages sequentially outputs a gate signal to an associated gate line.

A current stage among the stages includes a gate section, a carry section, a buffer section and a reset section. The gate section outputs a current gate signal and the carry section outputs a current carry signal. Except for the first stage in the group of the stages, the buffer section receives a previous carry signal from a previous stage to turn on the gate section and the carry section in response to the previous carry signal. The reset section receives a next carry signal from a next stage to turn off the gate section and the carry section in response to the next carry signal.

According to the gate drive circuit of the display device, the current stage is reset by receiving a next carry signal so that a reset function of the gate drive circuit can be improved in which the next stage carry signal has less distortion than a next stage gate signal.

### BRIEF DESCRIPTION OF THE DRAWINGS

FIG. 1 is a plan view of a liquid crystal display device according to one embodiment of the present invention.

FIG. 2 is a block diagram of a gate drive circuit 210 shown in FIG. 1.

FIG. 3 is a circuit of the n'th stage shown in FIG. 2.

FIG. 4 is a waveform of a carry signal and a gate signal.

FIGS. 5A and 5B are magnified drawings of the waveforms in dashed line areas I and II, respectively, shown in FIG. 4.

FIGS. 5C and 5D are magnified drawings of the waveforms in dashed line areas, III and IV, respectively, shown in FIG. 4.

FIG. 6 is a plan view of a liquid crystal display device according to another embodiment of the present invention.

FIG. 7 is a block diagram of a first and second gate drive circuits 210 and 330 shown in FIG. 6.

### DETAILED DESCRIPTION OF THE EMBODIMENTS

The present invention is described more fully hereinafter with reference to the accompanying drawings, in which preferred embodiments of the invention are shown.

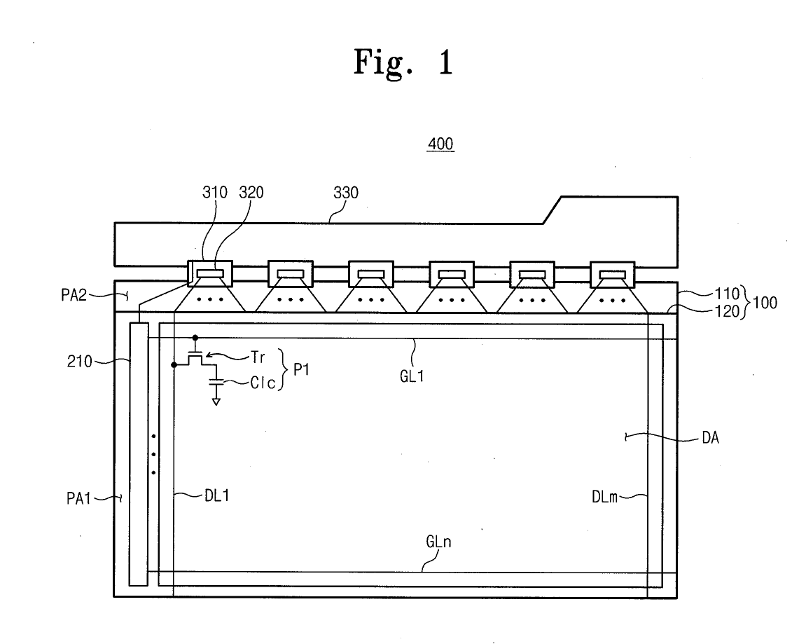

FIG. 1 is a plan view of a liquid crystal display device according to one embodiment of the present invention.

Referring to FIG. 1, a liquid crystal display device 400 includes a display panel 100 for displaying an image, a data drive chip 320 for providing data signals to the display panel 100, and a gate drive circuit 210 for providing gate signals to the display panel 100. The display panel 100 includes a lower substrate 110, an upper substrate 120 facing the lower substrate 110, and a liquid crystal layer interposed therebetween (not shown). The display panel 100 includes a display area DA and a peripheral area PA, in which the peripheral area includes a first peripheral area PA1 and a second peripheral area PA2.

In the display area DA, a plurality of pixel areas are formed at the intersections of the data lines DL1˜DLm and gate lines GL1˜GLn. Each pixel area includes a pixel P1 comprising a thin film transistor Tr and a liquid crystal capacitor Clc.

According to one embodiment of this invention, a gate electrode of the thin film transistor Tr is coupled to a first gate line GL1, a source electrode is coupled to a first data line DL1, and a drain electrode which is electrically coupled to a pixel electrode which is a first electrode of the liquid crystal capacitor Clc. The gate drive circuit 210 is formed on the first peripheral area PA1 which is adjacent to first terminals of the gate lines GL1˜GLn. The gate drive circuit 210 is coupled to the first terminals of the gate lines GL1˜GLn, and the gate signals are sequentially provided to the gate lines GL1˜GLn.

One embodiment of this invention provides a gate drive circuit 210 formed by thin film manufacturing process while pixels are formed on the lower substrate 110. The gate drive circuit 210 is directly formed in the lower substrate 110 so that there is no need to use the drive chips each chip including the gate drive circuit. Therefore, the liquid crystal display device 400 can be manufactured more efficiently and the overall size of the liquid crystal display device 400 can be reduced.

In the second peripheral area PA2 which is adjacent to a first terminal of the data lines DL1˜DLm, a plurality of Tape Carrier Packages (TCP) 310 are attached. Each data drive chip 320 is formed on the each Tape Carrier Package 310. The data drive chips 320 are coupled to and provide data voltages to first terminals of the data lines DL1˜DLm.

The liquid crystal display device 400 further includes a printed circuit board 330 for controlling the gate drive circuit 210 and the data drive chips 320.

From the circuitries (not shown) of the printed circuit board 330, each data drive chip 320 receives a data control signal and an image data, and also each gate drive circuit 210 receives a gate control signal. The data control signal and the image data are provided to the data drive chips 320 via the Tape Carrier Packages TCP 310. The gate control signal is provided to the gate drive circuit 210 through the one of Tape Carrier Packages which is adjacent to the gate drive circuit 210.

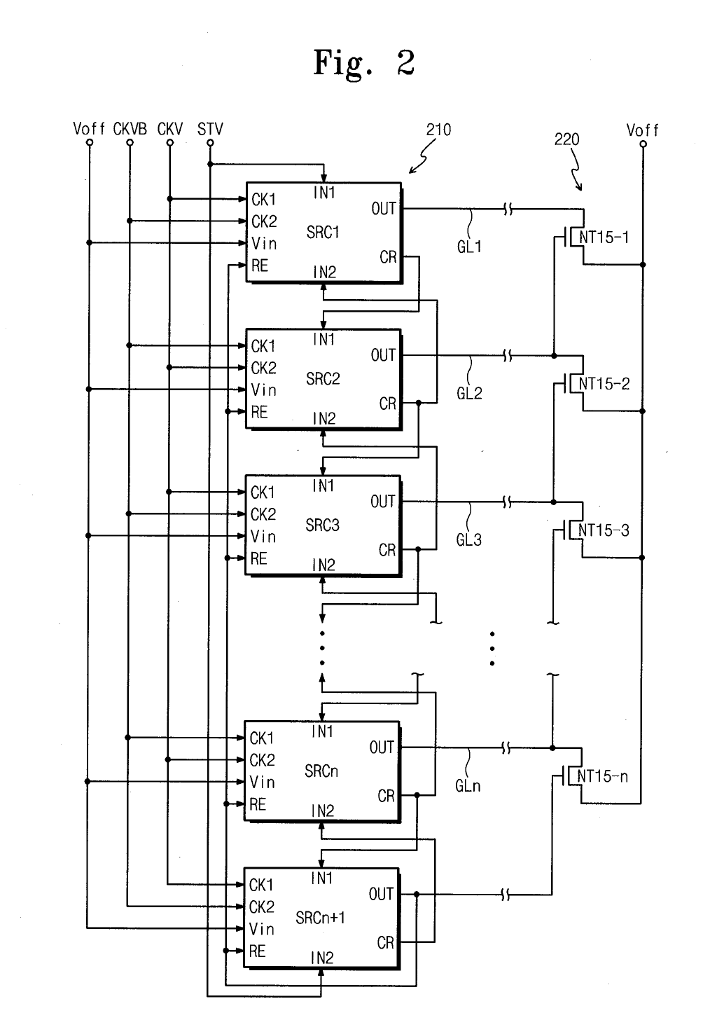

FIG. 2 is a block diagram of the gate drive circuit 210 shown in FIG. 1.

Referring to FIG. 2, the gate drive circuit 210 includes a shift resister having several stages SRC1˜SRCn+1 which are sequentially coupled as illustrated in the figure.

Each stage includes a first input terminal IN1, a second input terminal IN2, a first clock terminal CK1, a second clock terminal CK2, a reset terminal RE, a stage output terminal OUT, and a carry terminal CR. With the exception of stage SRC1, each of the first input terminals IN1 of the stages SRC2˜SRCn+1 is coupled to a previous stage carry terminal CR, and therefore receives a previous stage carry signal. The first input terminal IN1 of the first stage SRC1 receives a start signal STV indicating that the gate drive circuit 210 is to start to drive sequence.

With the exception of stage SRCn+1, each of the second input terminals IN2 of stages SRC1˜SRCn is coupled to a next stage carry terminal CR, and therefore receives a next stage carry signal. The second input terminal IN2 of the last stage SRCn+1 receives the start signal STV.

In odd-numbered stages SRC1, SRC3, . . . SRCn+1 among the stages SRC1˜SRCn+1, the first clock terminal CK1 receives a first clock CKV and the second clock terminal CK2 receives a second clock CKVB which is an inversion clock of the first clock CKV.

In even-numbered stages SRC2, . . . , SRCn among the stages SRC11 SRCn+1, the first clock terminal CK1 receives the second clock CKVB and the second clock terminal CK2 receives the first clock CKV. Each of the voltage input terminals Vin in the stages receives a ground voltage or a gate off voltage Voff. The stage output terminal OUT of the last stage SRCn+1 is coupled to reset terminals RE of all of the stages SRC1˜SRCn.

Therefore, stages SRC1˜SRCn sequentially output gate signals through the stage output terminals OUT to the respective associated gate lines GL1˜GLn.

As shown in FIG. 2, the gate drive circuit 210 is formed at a first terminal of the gate lines GL1˜GLn. The liquid crystal display device 400 of FIG. 1 further includes a discharge circuit 220 which discharges a current stage gate line to have a gate off voltage Voff in response to a next stage gate signal of the next stage at a second terminal of the gate lines GL1˜GLn.

The discharge circuit 220 includes a plurality of discharge transistors NT15-1, NT15-2, NT15-3, . . . NT15-n which are connected to second terminals of the gate lines in one-to-one fashion. Each discharge transistors NT15-1, NT15-2, NT15-3, . . . NT15-n includes a control electrode coupled to the gate line of the next stage, an input electrode receiving the gate off voltage Voff, and an output electrode coupled to the current stage gate line.

Each discharge transistors NT15-1, NT15-2, NT15-3, . . . NT15-n discharges a current stage gate signal by coupling voltage Voff to the current stage gate line in response to receipt at its gate electrode of the next stage gate signal.

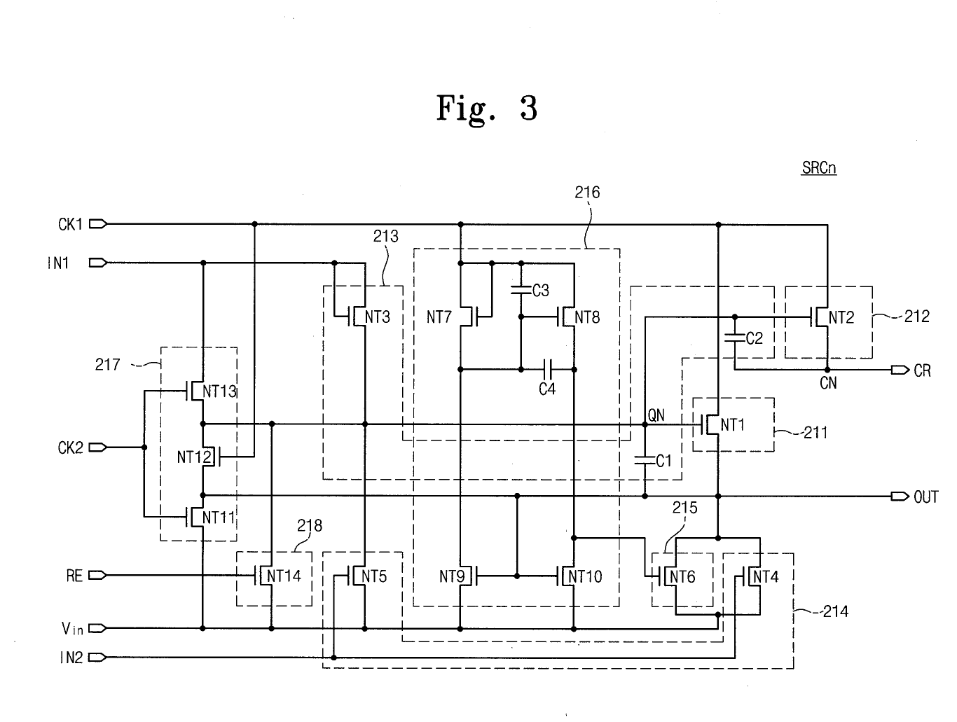

FIG. 3 is a circuit diagram of n'th stage SRCn shown in FIG. 2. Because each stage has internally the same circuit configuration, explanation of other stages is not necessary.

Referring to FIG. 3, n'th stage SRCn includes a gate section 211, a carry section 212, a buffer section 213, a reset section 214, a holding section 215, an inverter section 216, a ripple protection section 217, and a frame reset section 218.

The gate section 211 includes an output transistor NT1 which comprises a control electrode coupled to an output node QN (Hereinafter described as Q node) of the buffer section 213, an input electrode coupled to a first clock terminal CK1 and an output electrode coupled to a stage output terminal OUT.

The output transistor NT1 pulls up a current stage gate signal up to as much as a first clock CKV provided from the first clock terminal CK1 in response to a control voltage provided from the buffer section 213, in which the stage output terminal OUT receives the current stage gate signal.

During one frame period, the output transistor NT1 turns on only for 1H period which is a period that the first clock CKV is high, so that the current stage gate signal preserves high for 1H period. The carry section 212 includes a carry transistor NT2 which comprises a control electrode coupled to the Q node QN, an input electrode coupled to the first clock terminal CK1, and an output electrode coupled to the carry terminal CR.

The carry transistor NT2 pulls up a current stage carry signal up to as much as the first clock CKV in response to a control voltage provided from the buffer section 213.

During one frame period, the carry transistor NT2 turns on only for 1H period so that the current stage carry signal can be preserved high for 1H period. The carry terminal CR and an output terminal of the carry transistor NT2 are coupled at a current stage carry node CN. The buffer section 213 includes a buffer transistor NT3, a first capacitor C1, and a second capacitor C2.

The buffer transistor NT3 includes an input electrode, a control electrode, and an output node coupled to the Q node QN, in which the input electrode and the control electrode are both commonly coupled to a first input terminal IN1.

The first capacitor C1 is formed between the Q node and the stage output terminal OUT, and the second capacitor C2 is formed between the control electrode of the carry transistor NT2 and the carry terminal CR. When the buffer transistor NT3 turns on in response to a previous stage carry signal, the first and the second capacitors C1, C2 are charged. If the first capacitor C1 is charged over the threshold voltage of output transistor NT1, the output transistor NT1 and the carry transistor NT2 are turned on according as the electric potential of the Q node ON rises up over the threshold voltage.

As a result, the first clock CKV is provided to the output terminal and the carry terminal CR, so the current stage gate signal and carry signal vary to high state.

Namely, the current stage gate signal and carry signal have high state during a 1H period having high stage of the first clock CKV.

The reset section 214 includes a first reset transistor and a second reset transistor NT4, NT5. The first reset transistor NT4 includes a control electrode coupled to a second input terminal IN2, an input terminal coupled to a voltage input terminal Vin, and an output electrode coupled to a stage output terminal OUT.

Accordingly, the first reset transistor NT4 pulls down the current stage gate signal as much as a gate off voltage Voff provided from the voltage input terminal Vin in response to a next stage carry signal, in which the current stage gate signal has a pulled up level by the first clock CKV. Namely, the current stage gate signal pulls down low after 1H period.

The second reset transistor NT5 includes a control electrode coupled to the second input terminal IN2, an input electrode coupled to the Q node QN, and an output electrode coupled to the voltage input terminal Vin. The second reset transistor NT5 is turned on in response to the next stage carry signal, and an electric charge charged in the first and second capacitors C1, C2 is discharged to have a gate off voltage Voff via the second reset transistor NT5.

Therefore, an electric potential of the Q node QN goes to the gate off voltage Voff in response to the next stage carry signal so that the output transistor NT1 and the carry transistor NT2 are turned off.

Namely, as the second transistor NT5 is turned on for 1H period, the output transistor NT1 and the carry transistor NT2 are turned off so that a current stage gate signal and a current stage carry signal are not generated.

As a result, the reset section 214 functions to reset the current stage SRCn in response to the next stage carry signal.

The holding section 215 includes a holding transistor NT6 to hold a current stage gate signal at a discharge state. The holding transistor NT6 includes a control electrode coupled to an output terminal of the inverter section 216, an input electrode coupled to the voltage input terminal Vin, and an output electrode coupled to the current stage output terminal OUT.

Accordingly, the holding transistor NT6 holds the current stage gate signal to a gate off voltage Voff in response to an output signal of the inverter section 216. The inverter section 216 receives the first clock CKV and the current stage gate signal, and turns off or turns on the holding transistor NT6 by providing the current stage gate signal and an inverted signal of the first clock CKV. The inverter section 216 includes a first to fourth inverter transistors NT7, NT8, NT9, NT10, and a third to fourth capacitors C3, C4.

The first inverter transistor NT7 includes an input electrode, a control electrode, and an output electrode coupled to the output terminal of the inverter section 217 via the fourth capacitor C4, in which the input electrode and the control electrode are commonly coupled to the first clock terminal CK1. The second inverter transistor NT8 includes an input electrode coupled to the first clock terminal CK1, a control electrode coupled to the input electrode via the third capacitor C3, and an output electrode coupled to the output terminal of the inverter section 216.

The third inverter transistor NT9 includes an input electrode coupled to an output terminal of the first inverter transistor NT7, a control electrode coupled to the stage output terminal OUT, and an output electrode coupled to the voltage input terminal Vin. The fourth inverter transistor NT10 includes an input electrode coupled to the holding transistor NT6, a control electrode coupled to the stage output terminal OUT, and an output electrode coupled to the voltage input terminal Vin.

When the current stage gate signal provides a high to the inverter section 216, the third and the fourth inverter transistors NT9, NT10 are turned on in response to the current stage gate signal. Then the first and second inverter transistors NT7, NT8 output the first clock CKV as high. The first clock CKV which outputs from the first and second inverter transistors NT7, NT8 is discharged to the gate off voltage Voff via the third and fourth inverter transistors NT9, NT10.

While the current stage gate signal has high for 1H period, the inverter section 216 generates the gate off voltage Voff so that the holding transistor NT6 turns off. When the current stage gate signal becomes low, the third and fourth inverter transistors NT9 and NT10 are turned off.

Therefore, the first clock CKV generated from the first and second inverter transistors NT11, NT12, both high, is provided to an output terminal of the inverter section 216, so the holding transistor NT6 is turned on in response to the first clock CKV.

As a result, the current stage gate signal holds the gate off voltage Voff while the first clock CKV is high during (n−1) H period by the holding transistor NT6.

The ripple protection section 217 protects for the current stage gate signal and the current stage carry signal from ripple which can be caused by the first and second clock CKV, CKVB during the remaining time (n−1) H period of the 1H period. The ripple protection section 217 includes first to third ripple protection transistors, NT11, NT12, and NT13. The first ripple protection transistor NT11 includes an input electrode coupled to the stage output terminal OUT, a control electrode coupled to the second clock terminal CK2, and an output electrode coupled to the voltage input terminal Vin.

The second ripple protection transistor NT12 includes a control electrode coupled to the first clock terminal CK1, an input electrode coupled to the Q node QN, and an output electrode coupled to the stage output terminal OUT. The third ripple protection transistor NT13 includes a control electrode coupled to the second clock terminal CK2, an input electrode coupled to the terminal IN1, and an output electrode coupled to the Q node QN.

The first ripple protection transistor NT11 is turned on in response to a second clock CKVB applied to the second clock terminal CK2 so that the stage output terminal OUT can couple to the voltage input terminal Vin via the first protection transistor NT11. So, the current stage gate signal providing to the stage output terminal OUT is discharged to gate off voltage Voff via the first ripple protection transistor NT11 during high period of the second clock CKVB. The second ripple protection transistor NT12 is turned on in response to the first clock CKV so that the stage output terminal OUT can be electrically coupled to the Q node QN.

Therefore, the Q node QN receives the current stage gate signal. During the (n−1)H period, electric potential of the Q node QN is decreased to the current stage gate signal preserving the gate off voltage Voff while the first clock CKV is high.

Accordingly, the second ripple protection transistor NT12 can prevent the output and the carry transistors NT1, NT2 from being turned on during the high period of the first clock CKV is within the second period (n−1)H.

The third ripple protection transistor NT13 is turned on in response to the second clock CKVB applied to the second clock terminal CK2 to electrically connect the first input terminal IN1 can couple to Q node QN.

Therefore, the third ripple protection transistor NT13 provides the previous stage carry signal to the Q node QN, so the electric potential of the Q node QN is maintained at the gate off voltage Voff.

The above ripple protection section 217 stabilizes the electric potential of the Q node QN at the gate off voltage Voff during the second period (n−1)H out of one frame period thereby reducing ripple of the current stage gate signal and the current stage carry signal. The frame reset section 218 is electrically coupled to an output terminal of the last stage SRCn+1, and includes a frame reset transistor NT14 for resetting the current stage SRCn in response to the last stage gate signal.

The frame reset transistor NT14 includes a control electrode coupled to a reset terminal RE, an input electrode coupled to the control electrode of the output transistor NT1, and an output electrode coupled to the voltage input electrode Vin. The frame reset transistor NT14 discharges the electric potential of the Q node QN to the gate off voltage Voff in response to the last stage gate signal applied from the reset terminal RE.

So, the current stage SRCn can be reset by the last stage gate signal which is during a blank period between two consecutive frame periods.

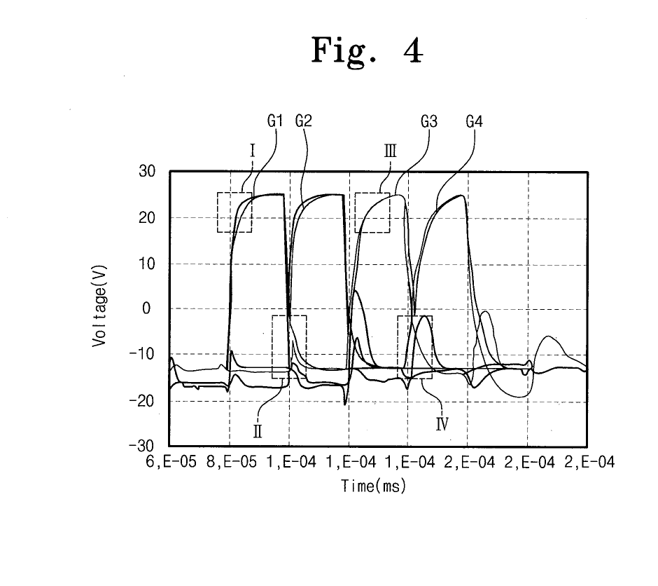

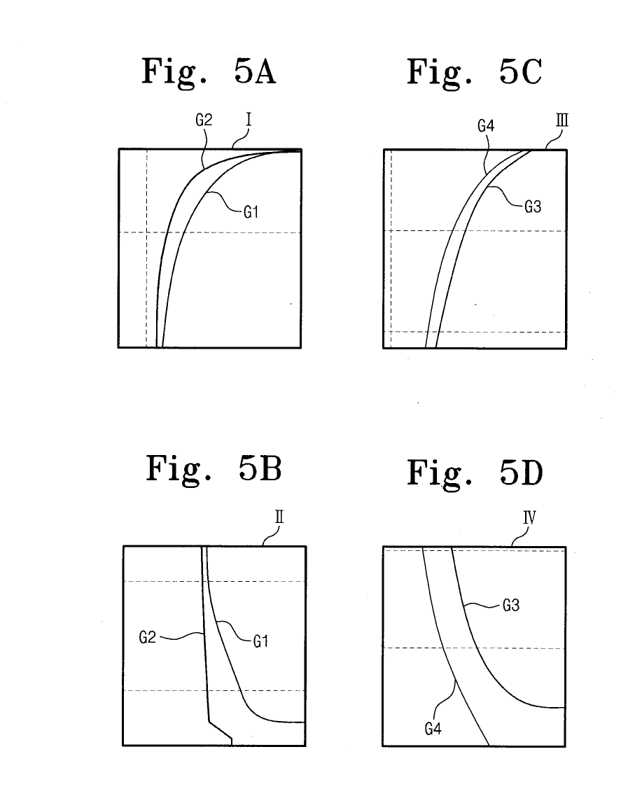

FIG. 4 is a waveform of a carry signal and a gate signal. FIGS. 5A and 5B are enlarged drawings of regions I and II shown in FIG. 4, and FIGS. 5C and 5D are enlarged drawings of regions III and IV shown in FIG. 4.

In FIG. 4 and FIG. 5A to FIG. 5D, the x-axis indicates time (ms) and the y-axis indicates voltage (V). Also, a first curve G1 and third curve G3 indicate gate signals, and a second curve G2 and a fourth curve G4 indicate carry signals.

Referring to FIG. 4 and FIG. 5A to FIG. 5D, a carry signal responds faster than a gate signal, namely, the carry signal has a lower time delay than the gate signal. By applying the carry signal to every reset section of the stages, in which the carry signal shows a low distortion, each stage in the gate drive circuit 210 can be reset in response to the next stage carry signal.

As the gate drive circuit 210 has an increased reset function, the gate drive circuit 210 can increase an output capability.

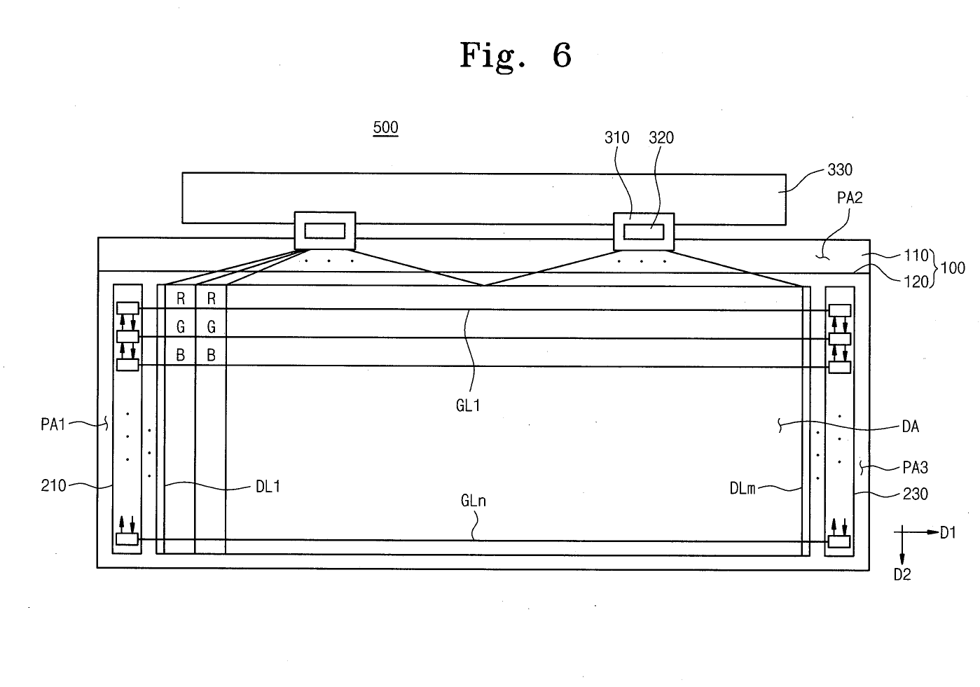

FIG. 6 is a plan view of a liquid crystal display device according to another embodiment of the present invention.

The same numeral used in FIG. 1 are also used to common elements which are the same as or similar to that shown in FIG. 1 and accordingly those common elements are not described.

Referring to FIG. 6, a liquid crystal display device 500 shows a lower substrate 110 including a display region DA for displaying image and a peripheral regions next to the display region, in which the peripheral regions include a first to third peripheral region, PA1, PA2 and PA3. The first peripheral region PA1 is a contiguous area of the first end point of the gate lines GL1˜GLn and includes a first gate drive circuit 210 for sequentially applying gate signals to the gate lines GL1˜GLn. The first gate drive circuit 210 includes a first shift register having a plurality of first stages each stage coupled with dependent connection. The stage output terminals of the first stages are coupled to the first end points of the gate lines GL1˜GLn, respectively.

As the first stages are sequentially turned on, gate signals are sequentially applied to the first end points of the corresponding gate lines. The third peripheral region PA3 is a contiguous area of the second end point of the gate lines GL1˜GLn and includes a second gate drive circuit 230 for sequentially applying gate signals to the gate lines GL1˜GLn.

The second gate drive circuit 230 includes a second shift register having a plurality of second stages each stage coupled with dependent connection. The stage output terminals of the plural second stages are coupled to the second end points of the gate lines GL1˜GLn, respectively.

As the plural second stages are sequentially turned on, gate signals are sequentially applied to the second end points of the corresponding gate lines.

Thus, each gate line receives the same gate signal via the first end and the second end point because each gate line is coupled to the first gate drive circuit 210 and the second gate drive circuit 230. Therefore, time delay according to the position of pixels can be minimized.

According to one embodiment of this invention, the first gate drive circuit 210 and the second gate drive circuit 230 are formed on the lower substrate 110 via thin film manufacturing process. Thus, the use of driving chips which have the first gate drive circuit 210 and the second gate drive circuit 230 is not necessary in liquid crystal display device 500 so that the size of the display device 500 can be minimized. Though not shown in figures, the pixels arranged on the lower substrate 110 have a horizontal pixel structure in which the pixels have a length in a first direction D1 longer than a length in a second direction D2 substantially perpendicular to the first direction D1. In the horizontal pixel structure, three color pixels displaying red, green, and blue are sequentially arranged along the second direction D2. Wherein, a unit pixel is defined as the three color pixels to display one color.

The horizontal pixel structure increases the number of gate lines and decreases the number of data lines. Though the number of gate lines is increased, because the first and second gate drive circuits 210, 230, are formed on the lower substrate 110, the number of chips is not increased.

Therefore, the number of data lines is decreased so that the liquid crystal display device 500 can minimize the use of data drive chips 320 and can be increased in productivity.

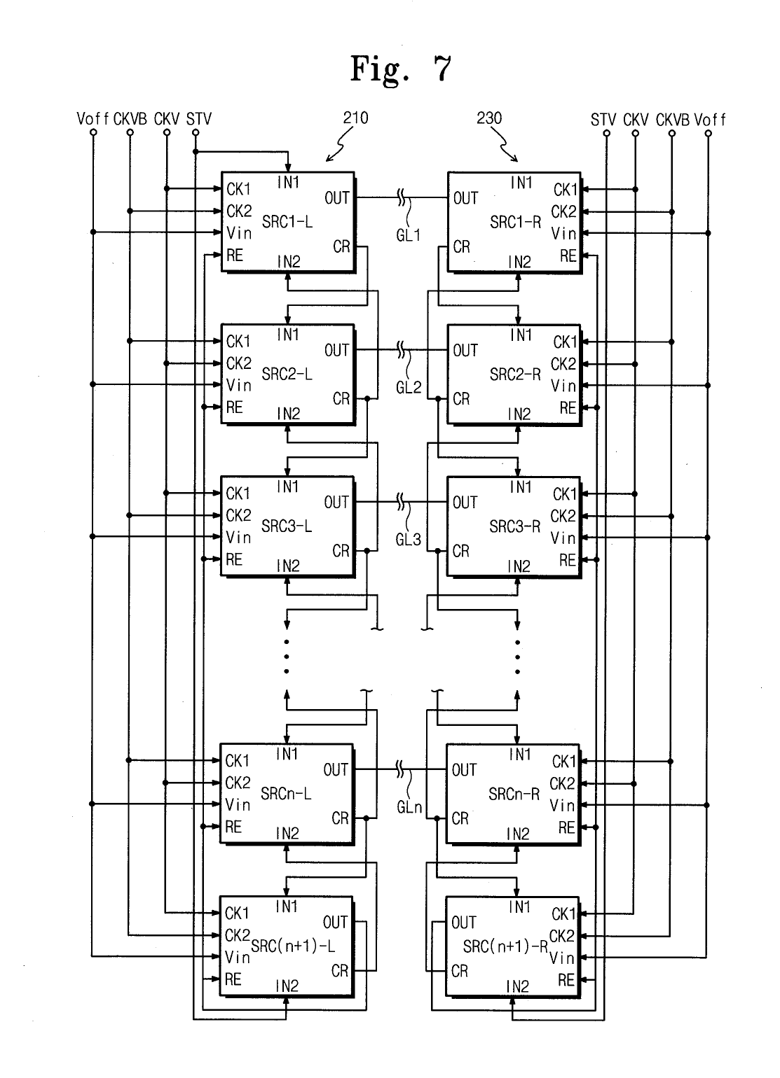

FIG. 7 is a block diagram of the first and second gate drive circuits shown in FIG. 6.

Referring to FIG. 7, a first gate drive circuit 210 includes a first shift register including first stages SRC1-L˜SRC(n+1)-L each stage coupled with dependent connection.

Each first stage includes a first input terminal IN1, a first and second clock terminal CK1, CK2, a second input terminal IN2, a voltage input terminal Vin, a reset terminal RE, an stage output terminal OUT and a carry terminal CR. Each first input terminal IN1 of the first stages SRC1-L˜SRC(n+1)-L is electrically coupled to carry terminals CR of a previous first stage and receives a previous stage carry signal, and the second input terminal IN2 is electrically coupled to a carry terminal CR of next first stage and receives a next stage carry signal.

Stage output terminals OUT of the first stages SRC1-L˜SRCn-L are electrically coupled to first ends of the gate lines GL1, GL2, GL3, . . . GLn, respectively. Thus, the first stages SRC1-L˜SRCn-L sequentially provide gate signals to the first ends of the gate lines GL1˜GLn.

Also, the second gate drive circuit 230 includes a second shift register which includes second stages SRC1-R˜SRC(n+1)-R each stage coupled with dependent connection.

The second stage also includes a first input terminal IN1, a first and second clock terminal CK1, CK2, a second input terminal IN2, a voltage input terminal Vin, a reset terminal RE, an stage output terminal OUT and a carry terminal CR.

Each first input terminal IN1 of the first stages SRC1-R˜SRC(n+1)-R is electrically coupled to a carry terminal CR of a previous second stage and receives a previous stage carry signal, and the second input terminal IN2 is electrically coupled to a carry terminal CR of a next second stage and receives a next stage carry signal.

The stage output terminals OUT of the second stages SRC1-R˜SRCn-R are electrically coupled to second ends of the gate lines GL1, GL2, GL3, . . . GLn, respectively. Thus, the second stages SRC1-R˜SRCn-R sequentially provide gate signals to the second ends of the gate lines GL1˜GLn.

In the first gate drive circuit 210 and the second gate drive circuit 230 which are formed at opposite ends of the lower substrate, the first and second stages are reset by next stage carry signal from the second input terminal.

Because pixels are coupled to the stage output terminals generating gate signals, the next stage carry signal has a low distortion than the next gate signal.

Therefore, as the first and second stages are reset in response to the next stage carry signal having low distortion instead of next stage gate signal, the function of the first and second gate drive circuit 210, 230 can be increased.

According to this liquid crystal display device having such a gate drive circuit, the current stage receives a next stage carry signal having low distortion than the next stage gate signal in order to reset a current stage. So, a reset function of the gate drive circuit can be increased and therefore the output characteristic of the gate drive circuit can be increased.

Since the above embodiments are described only for examples, the present invention is not limited to the above embodiments and various modifications or alternations can be easily made therefrom by those skilled in the art without departing from the scope of the present invention.

What is claimed is:

1. A gate drive circuit for a display device, the gate drive circuit having a plurality of stages comprising:
a current stage;
at least one previous stage coupled to the current stage; and
at least one next stage coupled to the current stage,
wherein, the current stage includes a gate section generating a current gate signal, a carry section generating a current carry signal, a buffer section receiving a previous carry signal from the previous stage to turn on the gate section and the carry section in response to the previous carry signal, and a reset section receiving a next carry signal from the next stage to turn off the gate section and the carry section in response to the next carry signal.

2. The gate drive circuit of claim 1, wherein the reset section comprises;
a first reset transistor being operative to turn off the gate section and the carry section in response to the next carry signal; and
a second reset transistor being operative to discharge the current gate signal in response to the next carry signal.

3. The gate drive circuit of claim 2, wherein the first reset transistor comprises a control electrode receiving the next carry signal, an input electrode receiving a gate off voltage, and an output electrode coupled to the gate section and to a control terminal of the carry section.

4. The gate drive circuit of claim 2, wherein the second transistor comprises a control electrode receiving the next carry signal, an input electrode receiving a gate off voltage, and an output electrode coupled to an output terminal of the gate section.

5. The gate drive circuit of claim 1, wherein the gate section comprises an output transistor having a control electrode coupled to an output terminal of the buffer section, an input electrode receiving a first clock, and an output electrode generating the current gate signal, and the carry section comprises a carry transistor having a control electrode coupled to the output terminal of the buffer section, an input electrode receiving the first clock, and an output electrode outputting the current carry signal.

6. The gate drive circuit of claim 5, wherein the buffer section comprises a buffer transistor of which a control electrode and an input electrode are electrically connected to each other to commonly receive the previous carry signal, and an output electrode is coupled to the control electrode of the output transistor of the gate section and to the control electrode of the carry transistor of the carry section.

7. The gate drive circuit of claim 5, wherein the current stage comprises:
a holding section to hold the current gate signal in state of discharge;
an inverter section receiving the first clock and the current gate signal and generating an inverted signal for the current gate signal to turn on or turn off the holding section;
a ripple protection section receiving the first clock and the second clock which is an inverted signal of the first clock and preventing signals providing to the gate section and the control electrode of the carry section from being rippled; and
a frame reset section resetting the current stage in response to a last gate signal from last stage among stages.

8. A display device comprising:
a display panel displaying image with a plurality of gate lines, a plurality of data lines, and a plurality of pixels;
a data drive circuit coupled to the data lines and generating data signals;
a gate drive circuit sequentially generating gate signals and including a plurality of stages connected to each other one after another; and
wherein, a current stage of the stages includes a gate section generating a current gate signal, a carry section coupled to the at least one previous stage to generate a current carry signal, a buffer section receiving a previous carry signal from a previous stages to turn on the gate section and the carry section in response to the previous carry signal, and a reset section receiving a next carry signal from a next stages to turn off the gate section and the carry section in response to the next carry signal

9. The display device of claim 8, wherein the reset section comprises;
a first reset transistor being operative to turn off the gate section and to turn off the carry section in response to the next carry signal; and
a second rest transistor being operative to discharge the current gate signal in response to the next carry signal.

10. The display device of claim 9, wherein the first reset transistor comprises a control electrode receiving the next carry signal, an input electrode receiving a gate off voltage, and an output electrode coupled to the gate section and a control terminal of the carry section.

11. The display device of claim 9, wherein the second transistor comprises a control electrode receiving the next carry signal, an input electrode receiving a gate off voltage, and an output electrode coupled to an output terminal of the gate section.

12. The display device of claim 8, wherein the gate drive circuit is directly provided on the display panel with a thin film manufacturing process applied to form the pixels, and the stages are correspondingly coupled to first end parts of the gate lines.

13. The display device of claim 12 further comprising a discharge circuit comprising a plurality of discharge transistors electrically correspondingly coupled to second ends, wherein a current stage discharge transistor of the discharge transistors discharging a current gate signal in response to a next gate signal from the next stage.

14. The display device of claim 13, wherein the current stage discharge transistor comprises a control electrode receiving the next gate signal, an input electrode receiving a gate off voltage, and an output electrode coupled to a current stage gate line.

15. A liquid crystal display device comprising:
a display panel displaying image with a plurality of gate lines, a plurality of data lines, and a plurality of pixels;
a data drive circuit coupled to the data lines and generating data signals;
a first gate drive circuit including a plurality of first stages connected to each other one after another and sequentially generating first gate signals; and
a second gate drive circuit including a plurality of second stages connected to each other one after another and sequentially generating second gate signals,
wherein, a first current stage of the first stages comprises a first gate section generating a first current gate signal, a first carry section generating a first current carry signal, a first buffer section receiving a first previous carry signal from a first previous stage to turn on the first gate section and the first carry section, and a first reset section receiving a first next carry signal from a first nextstage to turn off the first gate section and the first carry section, a second current stage of the second stages comprises a second gate section generating a second current gate signal, a second carry section generating a second current carry signal, a second buffer section receiving a second previous carry signal from a second previous stage to turn on the second gate section and the second carry section, and a second reset section receiving a second next carry signal from a second next stage to turn off the second gate section and the second carry section.

16. A method of driving a gate drive circuit for a display device which has a plurality of stages, the method driving a current stage among the stages comprising:
receiving a previous carry signal from a previous stage;
generating a current gate signal and a current carry signal in response to the previous carry signal;
receiving a next carry signal from a next stage; and
resetting the current gate signal and the current carry signal in response to the next carry signal.

17. The method of claim 16, wherein the resetting the current gate signal and the current carry signal comprises:
turning off a gate section and a carry section of the current stage in response to the next carry signal; and
discharging the current gate signal in response to the next carry signal.

18. The method of claim 17, wherein the gate section of the current stage outputs the current gate signal, and the carry section of the current stage outputs the current carry signal.

19. The method of claim 16, wherein the previous stage, the current stage and the next stage are sequentially turned on.
